(19) United States
(12) Patent Application Publication
(10) Pub. No.: US 2012/0277922 A1
(43) Pub. Date: Nov. 1, 2012

(54) DEVICE AND METHOD FOR REDUCING THE ENERGY CONSUMPTION OF A MACHINE IN THE FIELD OF AUTOMATION ENGINEERING

(75) Inventors: MICHAEL GESCHWILL, Uehlfeld (DE); Andreas Grözinger, Renningen (DE)

(73) Assignee: Siemens Aktiengesellschaft, Munchen (DE)

(21) Appl. No.: 13/278,655

(22) Filed: Oct. 21, 2011

(30) Foreign Application Priority Data
Oct. 22, 2010 (EP) EP 10 188 561

(51) Int. Cl. G05F 5/00

(52) U.S. Cl. 700/291; 901/50

(57) ABSTRACT

A device and a method for reducing the energy consumption of a machine in automation engineering are disclosed. The device includes an operating unit with a display configured to display an operating mode of the machine and an operating functionality of the machine associated with the operating mode, wherein parameters associated with a selected operating functionality can be entered by an operator of the machine, and wherein the operating unit is configured to determine an energy consumption state for a selected operating functionality and the entered parameters. The energy consumption of a machine in the field of automation engineering can thereby be reduced.

### CROSS-REFERENCES TO RELATED APPLICATIONS

This application claims the priority of European Patent Application, Serial No. EP 10188561, filed Oct. 22, 2010, pursuant to 35 U.S.C. 119(a)-(d), the content of which is incorporated herein by reference in its entirety as if fully set forth herein.

This application is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “DEVICE AND METHOD FOR REDUCING THE ENERGY CONSUMPTION OF A MACHINE IN THE FIELD OF AUTOMATION ENGINEERING”, representative's docket no.: GESCHWILL.

### BACKGROUND OF THE INVENTION

The present invention relates to a device and method for reducing the energy consumption of a machine in the field of automation engineering.

The following discussion of related art is provided to assist the reader in understanding the advantages of the invention, and is not to be construed as an admission that this related art is prior art to this invention.

Machines in the field of automation engineering, such as e.g. machine tools, production machines and/or robots, have a very high energy consumption. In particular, machine tools have a very high energy consumption in this case.

It would be desirable and advantageous to provide an improved device and method for reducing the energy consumption of a machine in the field of automation engineering to obviate prior art shortcomings.

### SUMMARY OF THE INVENTION

According to one aspect of the present invention, a device for reducing the energy consumption of a machine in automation engineering includes an operating unit comprising a display configured to display an operating mode of the machine and an operating functionality of the machine associated with the operating mode, wherein parameters associated with a selected operating functionality can be entered by an operator of the machine, and an evaluation unit configured to determine an energy consumption state for a selected operating functionality and the entered parameters.

According to another aspect of the present invention, a machine in automation engineering includes a device for reducing the energy consumption of a machine in automation engineering, with device having an operating unit comprising a display configured to display an operating mode of the machine and an operating functionality of the machine associated with the operating mode, wherein parameters associated with a selected operating functionality can be entered by an operator of the machine, and an evaluation unit configured to determine an energy consumption state for a selected operating functionality and the entered parameters

According to still another aspect of the present invention, a method for reducing the energy consumption of a machine in automation engineering includes the steps of reading in a selected operating mode of the machine and a selected operating functionality of the machine associated with the selected operating mode, entering parameters associated with the selected operating functionality, and determining an energy consumption state for the selected operating functionality and the entered parameters.

Advantageous developments of the invention are derived from the dependent claims. Advantageous developments of the method are derived in a similar way to the advantageous developments of the device and vice versa.

According to another advantageous feature of the present invention, a trigger unit can be provided to receive the energy consumption state from the evaluation unit and being configured to trigger machine actuators based on the received energy consumption state. This allows compact construction of a machine in the field of automation engineering.

According to another advantageous feature of the present invention, a configuration interface can be provided, which is so designed as to specify the triggering of the machine actuators depending on the energy consumption state of the machine. This allows e.g. a manufacturer of the machine easily to specify which machine actuators must be switched on or off in response to a specific energy consumption state.

According to another advantageous feature of the present invention, the machine in the field of automation engineering can take the form of a machine tool, a production machine and/or a robot, for example.

According to yet another aspect of the present invention, a computer program for reducing energy consumption of a machine in automation engineering includes a program code embodied in a non-transitory medium, wherein the computer program when executed on a computer of the machine causes the machine to read in a selected operating mode of the machine and a selected operating functionality of the machine associated with the selected operating mode, read in entered parameters associated with the selected operating functionality, and determining an energy consumption state for the selected operating functionality and the entered parameters.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a block diagram of a machine which having incorporated a device according to the invention,

FIG. 2 shows a menu tree, and

FIG. 3 shows an entry mask.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

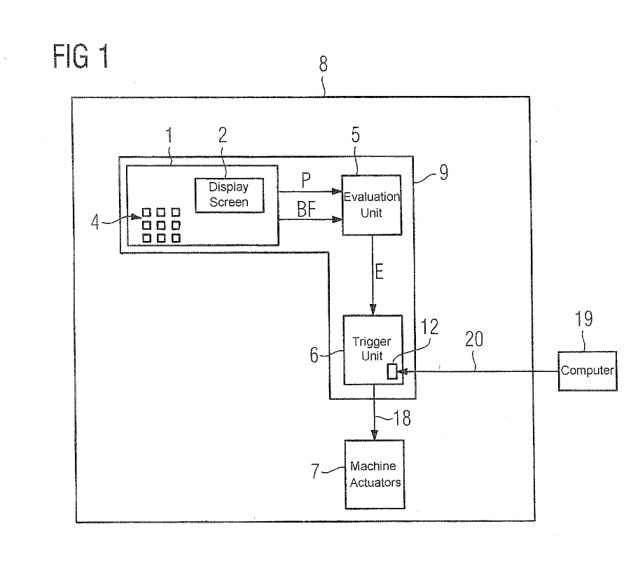

Turning now to the drawing, and in particular to FIG. 1, there is shown a schematic block diagram of a machine 8 in the field of automation engineering, with the machine 8 including a device 9 in accordance with the present invention for reducing the energy consumption of a machine in the field of automation engineering. In the context of the exemplary embodiment, the device 9 according to the invention takes the form of a CNC control (computer numerical control) in this case, wherein for the sake of clarity only those elements of the CNC control which are essential to the understanding of the invention are shown in FIG. 1. In the context of the exemplary embodiment, the device 9 according to the invention features an operating unit 1, an evaluation unit 5 and a trigger unit 6. In the context of the exemplary embodiment, the evaluation unit 5 and the trigger unit 6 in this case take the form of executable software code which is executed on one or more processors. The trigger unit 6 can take the form of an SPC (stored programmable control), for example. The operating unit 1, the evaluation unit 5 and the trigger unit 6 can be structurally realized in various components of the machine or alternatively in a single component of the machine.

In the context of the exemplary embodiment, the machine 8 takes the form of a machine tool.

In the context of the exemplary embodiment, the operating unit 1 has keys 4 and a display screen 2 for operating the machine 8. The operation of the machine 8 by means of the operating unit 1 is menu-driven in this case.

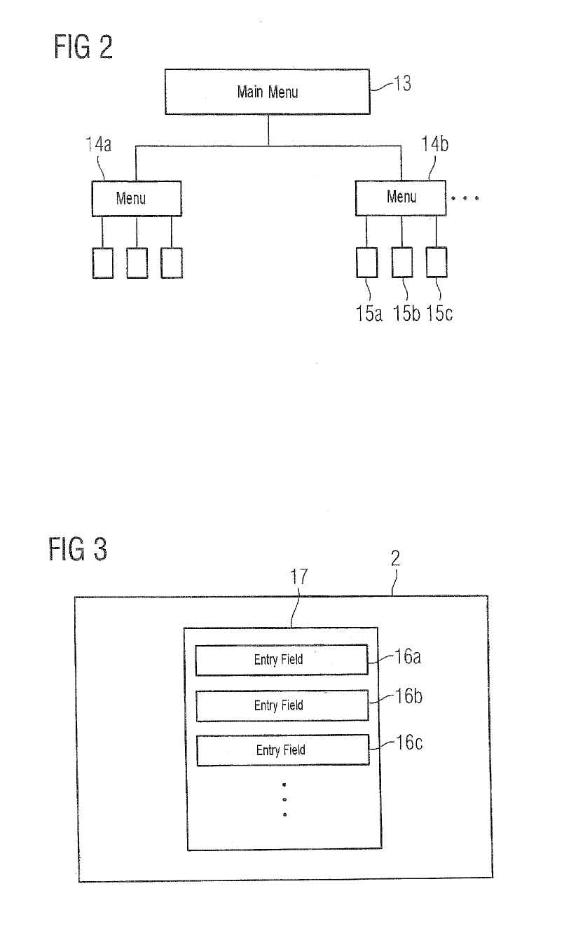

FIG. 2 shows a menu tree in the context of the exemplary embodiment. Using the corresponding keys 4, an operator of the machine can operate the machine 8 by invoking various menus and entry masks by means of the keys 4. Within a main menu 13 which is shown on the display screen 2, the operator of the machine can select various operating modes of the machine. The operator can select the operating mode of the machine by choosing from corresponding menus. In the context of the exemplary embodiment, the operator can select “automatic mode” as an operating mode by choosing the menu 14a, or “setup mode” as the operating mode by choosing the menu 14b. In addition to the two operating modes cited above, the machine can naturally feature further operating modes, as indicated in FIG. 2 by means of dots.

In the “automatic mode”, e.g. workpieces are processed by the machine. In this operating mode, the machine usually requires the maximum energy for processing the workpiece, since all or most of the machine actuators 7 (see FIG. 1) are usually active, e.g. the drives for moving machine axles, the spindle drive, hydraulic pumps, chip conveyors and/or coolant pumps. The operating modes in this case are assigned operating functionalities, these being associated with the relevant operating mode, wherein the operating functionalities are represented by small rectangles in FIG. 2. By pressing on corresponding keys 4, the operator can select e.g. the operating functionality “determine workpiece zero point”, which is denoted in FIG. 2 by the reference sign 15a, or the operating functionality “determine workpiece location” which is denoted by the reference sign 15b, or the operating functionality “position” which is denoted by the reference sign 15c. The operating functionality “determine workpiece zero point” 15b is used to determine the workpiece zero point, the operating functionality “determine workpiece location” is used to determine the workpiece location and the operating functionality “position” is used to carry out a movement, e.g. of a tool, relative to the workpiece.

When an operating functionality is selected by the operator, an entry mask 17 (see FIG. 3) that is associated with the currently selected operating functionality is displayed on the display screen 2 for the operator. In this case, the entry mask 17 has entry fields 16a, 16b and 16c, these being associated with the selected operating functionality, for the entry of parameters by the operator. It is naturally possible in this case for an entry mask to feature more than the three entry fields shown, this being indicated in FIG. 3 by means of dots. Using the entry fields, the operator can enter the parameters associated with the currently selected operating functionality.

The device 9 is therefore so designed that an operating mode of the machine 8 and an operating functionality of the machine 8 can be selected by an operator, wherein said operating functionality is associated with the operating mode. Furthermore, the device 9 is therefore so designed that parameters P which are associated with a selected operating functionality can be entered. The selected operating mode of the machine, the selected operating functionality of the machine 8, said selected operating functionality being associated with the selected operating mode of the machine 8, and the parameters that have been entered by the user and are associated with the selected operating functionality, are read in by the device 9.

The parameters P that have been entered and the selected operating functionality (denoted as BF in FIG. 1) are transferred as input variables to the evaluation unit 5 (see FIG. 1). The evaluation unit 5 determines an energy consumption state E on the basis of the selected operating functionality BF and the parameters P. In this case, the energy consumption state E can be “low”, “medium” or “high” in the context of the exemplary embodiment. For example, if the operator selects the operating functionality “position” in the operating mode “setup mode”, a corresponding entry mask that is associated with the operating functionality “position” will be displayed on the display screen 2 for the operator. The operating functionality “position” is used to move the tool, e.g. a milling cutter, to a specific position by means of the drives of the machine. As parameters, the operator now specifies in the entry field 16a the position to which the tool is to be moved in an X-direction, and in the entry field 16b the position to which the tool is to be moved in a Y-direction. Furthermore, the operator can enter as a parameter in the entry field 16c, for example, that the movement of the tool is to take place as a rapid traverse. It should be noted here that entry of a parameter does not necessarily have to be done by means of a keypad, but can also be done e.g. by clicking on a parameter from e.g. a selection of a plurality of parameters. This can be keypad-driven or effected e.g. by means of a computer mouse. As a result of the operator entering the parameter “rapid traverse” as a movement type in the operating functionality “position”, with the consequence that the movement of the tool takes place quickly, it can be recognized that the operator wishes to move the tool without any material removal. The machine actuators 7 of the machine, such as e.g. a coolant pump or the chip conveyor, are therefore not required when performing the selected operating functionality using the parameters that have been entered.

The evaluation unit 5 therefore determines the energy consumption state “low” and outputs this to the trigger unit 6. In the context of the exemplary embodiment, the evaluation unit 5 determines the energy consumption state E from the selected operating functionality and the parameters P that have been entered, with reference to a table in which the respective energy consumption state E is stored for every possible operating functionality and for the possible parameters that are associated with the operating functionality. If multiple occurrences of an operating functionality are present, e.g. in the setup mode and also in a further operating mode that is not shown in FIG. 2, then an energy consumption state E is ascertained by the device 9, in particular by the evaluation unit 5, on the basis of the selected operating mode, the selected operating functionality and the parameters that have been entered. For this purpose, the table is extended to include the “operating mode”.

If the operator enters e.g. “advance” instead of “rapid traverse” for the parameter “movement type”, this means that the operator now wants to mill an edge of the workpiece, for example. Therefore material removal will presumably occur at the workpiece in this case. Machine actuators such as e.g. the coolant pump (for recirculating the coolant liquid of the tool) and the chip conveyor must be switched on for this purpose. Since material removal will presumably occur at the workpiece, the machine actuator in the form of a spindle drive, which drives the milling cutter in a rotary manner, requires high power, i.e. the energy requirement of the spindle drive is relatively high. The evaluation unit 5 therefore determines the energy consumption state E “high”, signifying that a high energy consumption is required for performing the operating functionality that has been selected by the relevant parameters.

The operating mode “determine workpiece location” is used to determine the location of the workpiece. If the operator selects the operating functionality “determine workpiece location” and “manual scratching” is entered as a parameter in the entry mask that is associated with the operating functionality “determine workpiece location”, e.g. by making a corresponding choice from a list that is displayed within an entry mask, only a very small amount of workpiece material removal is performed by the milling cutter. In this context, the spindle drive drives the milling cutter in a rotary manner, and the milling cutter is moved in the direction of the workpiece until contact of the milling cutter with the workpiece is detected. Since almost no material removal or at most only very little material removal occurs at the workpiece, the spindle drive which drives the milling cutter in a rotary manner requires only a low power, i.e. the energy requirement of the spindle drive is only slight and the chip conveyor is switched off, wherein other machine actuators 7 such as e.g. the coolant pump are nonetheless active i.e. switched on. The evaluation unit 5 therefore determines the energy consumption state “medium” if “determine workpiece location” is selected as an operating functionality and the “manual scratching” parameter has been entered.

The energy consumption statuses E (“low”, “medium” and “high” in the context of the exemplary embodiment) are transferred from the evaluation unit 5 as an input variable to a trigger unit 6 in the context of the exemplary embodiment. The trigger unit 6 can take the form of e.g. an SPC (stored programmable control). The evaluation unit 5 can be e.g. part of an NC control of the machine 8. The trigger unit 6 is used for triggering the machine actuators 7. The trigger unit 6 controls the machine actuators 7 depending on the energy consumption state E of the machine 8, this being shown in FIG. 1 by means of an arrow 18. In this case, the machine actuators 7 are triggered by the inventive device 9 and in particular by the trigger unit 6 in such a way that, in the context of the exemplary embodiment, only those machine actuators that are assigned to a specific energy consumption state E are switched on. For example, all of the machine actuators 7 are switched on in the energy consumption state “high”, while only some of the machine actuators 7 are switched on in the energy consumption state “medium”, and an even smaller proportion of the machine actuators 7 are switched on in the energy consumption state “low”. In the context of the exemplary embodiment, for example, all of the machine actuators 7 are turned on by the trigger unit 6 in the energy consumption state “medium”, except for the chip conveyor. This remains turned off. In the energy state “low”, e.g. the coolant pump and the chip conveyor are not switched on.

In order to allow selective triggering of the machine actuators 7 depending on the energy consumption state, the trigger unit 6 can also perform the triggering of the machine actuators 7 depending on e.g. the selected operating functionality and/or depending on further variables.

In the context of the exemplary embodiment, the inventive device 9 and in particular the trigger unit 6 has a configuration interface 12, which is designed such that the triggering of the machine actuators can be specified depending on the energy consumption state E of the machine and possibly also depending on e.g. the selected operating functionality and/or depending on further variables. By means of the configuration interface 12, it is possible for e.g. a manufacturer of the machine to specify how the triggering of the machine actuators should take place depending on the energy consumption state and possibly on further variables of the machine. It is therefore possible to specify, for example, which machine actuators are active, i.e. switched on, in which energy consumption state. In this case, the configuration interface can be configured e.g. by means of an external arithmetic-logic unit 19 (e.g. personal computer), i.e. an arithmetic-logic unit which is not part of the machine 8, by integrating e.g. a corresponding program into the control unit 6 by means of the external arithmetic-logic unit 19, wherein said program specifies the triggering of the machine actuators depending on the energy consumption state. This is shown by means of an arrow 20 in FIG. 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A device for reducing the energy consumption of a machine in automation engineering, comprising:
an operating unit comprising a display configured to display an operating mode of the machine and an operating functionality of the machine associated with the operating mode, wherein parameters associated with a selected operating functionality can be entered by an operator of the machine, and
an evaluation unit configured to determine an energy consumption state for a selected operating functionality and the entered parameters.

2. The device of claim 1, further comprising a trigger unit receiving the energy consumption state from the evaluation unit and being configured to trigger machine actuators based on the received energy consumption state.

3. The device of claim 2, further comprising a configuration interface configured to trigger the machine actuators depending on the energy consumption state of the machine.

4. The device of claim 1, wherein the machine is a machine selected from the group of machine tool, production machine and robot.

5. A machine in automation engineering having a device for reducing the energy consumption of a machine in automation engineering, said device comprising:
an operating unit comprising a display configured to display an operating mode of the machine and an operating functionality of the machine associated with the operating mode, wherein parameters associated with a selected operating functionality can be entered by an operator of the machine, and
an evaluation unit configured to determine an energy consumption state for a selected operating functionality and the entered parameters.

6. A method for reducing the energy consumption of a machine in automation engineering, comprising the steps of:
reading in a selected operating mode of the machine and a selected operating functionality of the machine associated with the selected operating mode,
entering parameters associated with the selected operating functionality, and
determining an energy consumption state for the selected operating functionality and the entered parameters.

7. A computer program for reducing energy consumption of a machine in automation engineering, the computer program comprising a program code embodied in a non-transitory medium, wherein the computer program when executed on a computer of the machine causes the machine to
read in a selected operating mode of the machine and a selected operating functionality of the machine associated with the selected operating mode,
read in entered parameters associated with the selected operating functionality, and
determining an energy consumption state for the selected operating functionality and the entered parameters.
